(19) United States
(12) Patent Application Publication
(10) Pub. No.: US 2014/0081059 A1
(43) Pub. Date: Mar. 20, 2014

(54) CATALYSTS FOR PRODUCTION OF COMBUSTIBLE FUEL AND FIXED CARBONS FROM HOMOGENEOUS AND HETEROGENEOUS WASTE

(71) Applicant: Raghavendra Rao TURLAPATI, Mumbai (IN)

(72) Inventor: Raghavendra Rao TURLAPATI, Mumbai (IN)

(21) Appl. No.: 14/085,401

(22) Filed: Nov. 20, 2013

Related U.S. Application Data
(63) Continuation of application No. PCT/IN2012/000157, filed on May 3, 2012.

(30) Foreign Application Priority Data
May 20, 2011 (IN) 1543/MUM/2011

(51) Int. Cl. B01J 31/38; B01J 21/16

(52) U.S. Cl. CPC B01J 31/38; B01J 21/16
USPC 585/240; 502/62; 502/73; 502/159; 502/151

(57) ABSTRACT

Disclosed herein is an external, fixed bed, agglomerated nano catalyst of the general formula;

AₓB_{y}O_{z}.Qₙ.(OH)ₘ

where, ‘A’ represents transition element ‘B’ represents rare earth elements including the lanthanide series, and actinide series either alone or mixture thereof in metallic or oxide or as hydroxides; ‘Q’ represents montmorillonate clay or its derivatives; and optionally along with an organic binder; for conversion of various homogeneous and heterogeneous waste material into useful hydrocarbon fuel as oil, gas and as solid carbon.

### CROSS-REFERENCE TO RELATED APPLICATIONS

This application is a continuation of parent International Application No. PCT/IN2012/000157, filed on May 3, 2012, and published as WO 2012/160570 on Nov. 29, 2012. International Application No. PCT/IN2012/000157 claims priority to Indian application 1543/MUM/2011, filed on May 20, 2011. The entire disclosures of all prior applications are hereby incorporated by reference in their entirety.

### TECHNICAL FIELD OF INVENTION

The present invention relates to an external, fixed bed, agglomerated nano catalyst for conversion of homogenous and heterogeneous waste materials into hydrocarbon fuel fractions and carbon, and to a process for its preparation thereof.

### BACKGROUND OF THE INVENTION

Industrial revolution is significantly depleting natural resources thus leading to increasing competition for the available energy sources thereby hampering economic growth by high energy prices. At the same time various kinds of wastes are being generated all over the world like industrial wastes, domestic households, municipal corporations, agro wastes and wastes from rural developmental activities. These wastes include municipal solid and liquid wastes (MSW), polymeric wastes such as plastics, rubbers, hospital wastes, industrial wastes such as scraps, electronic and stationary wastes, fuel wastes from automobiles, wastes from petroleum refineries, wastes from edible and non-edible oil industry, slaughter house, wastes from the pulp and paper, wastes from palm and other oil seed crushing and expelling, boiler wastes and incinerator inputs and outputs, organic and human wastes. Dumping of garbage without proper disposal has become an increasing problem thus having adverse effect on the general health of the public and the ecosystem. Wasteful disposal or conversion by burning incineration etc. contributes to avoidable air pollution and global warming.

Plastics and polymeric plastic materials such as polyethylene, polypropylene, polyvinyl chloride, polystyrene, ABS etc. which are widely used in the industry and in our daily life are becoming a major threat to the ecosystem as they can hardly decompose by themselves under natural conditions. Apart from the plastic waste, electronic waste known as e-waste which include loosely discarded surplus, broken electronic or electrical devices, electronic scrap components contain contaminants such as lead, beryllium, mercury and brominated flame retardants which are not biodegradable thus amounting to the problems associated with its proper disposal. The plastics from e-waste are flame retardant, high melting temperature plastics which cannot be landfilled nor can be re-processed and recycled.

Further, the organic, biodegradable components of MSW are important, not only because it constitutes a sizable fraction of the solid waste stream in a developing country but also because of its potentially adverse impact on public health and environmental quality. One major adverse impact is its attraction of rodents and vector insects, for which it provides food and shelter. Impact on environmental quality takes the form of foul odors and unsightliness. These impacts are not confined merely to the disposal site; they pervade the surrounding area and anywhere that wastes are generated, spread, or accumulated. Unless organic waste is managed appropriately, its adverse impact continues until it has fully decomposed or otherwise stabilized. Moreover, incineration of such wastes requires additional input energy thereby impacting the overall cost of process.

In view of the above, several new methods have been developed for effective treatment of the waste material including the use of catalysts. There are many prior arts which have approached the problem of disposal or recycling of waste material by catalytic degradation with without much degree of success and outcomes.

U.S. Pat. No. 7,084,180 discloses a process for converting a reactant composition of syn gas to aliphatic hydrocarbon having at least five carbon atoms using a Fischer-Tropsch catalyst of formula CoM1aM9bOx wherein the M9 metal is selected from titanium, lanthanum etc. In one aspect, the invention discloses the use of bentonite as a support material.

CA2473751 discloses hybrid catalysts consisting of chemically treated microporous crystalline silicate such as the pentasil type silicate, a mesoporous silica-alumina or zirconium oxide co catatyst into which may be incorporated aluminium oxide, molybdenum oxide, lanthanum oxide, cerium oxide, and an inorganic binder such as bentonite. The catalyst is used in deep catalytic cracking of petroleum naphthas or other hydrocarbon feedstocks.

GB610080 relates to fluid catalysts selected from the oxides, sulphides, oxysulphides of Fe, Cr, Bi, Ce, Al, Cu, Ti, Ni, La, Zr, Mg, Si etc or their mixtures thereof. The said patent also discloses the use of bentonite along with the spent catalyst fines or fines produced in spray drying to form spheroidal catalysts particles. The said catalyst composition is used to carry out various chemical conversions such as cracking, reforming, hydrogenation etc. U.S. Pat. No. 4,968,661 discloses a catalyst composition AuMOw[(DOx)(eOy)a]z where ‘A’ is alkali or alkaline earth metals, ‘M’ is V, Cr, Mo, Mn, Fe, Co, Ni, Cu or a mixture thereof; ‘D’ is Zr, Ti, Th, Ce, etc or mixture thereof; ‘E’ is Ca, Mg, Sr, La, Nd, Bi, Eu, etc or mixtures thereof; ‘a’ is 0-0.2; ‘u’ is approx. 1, ‘w’ is the number of oxygen needed to fulfill the valence requirement of A and M; ‘x’ is the number of oxygen needed to fulfill the valence requirement of D; ‘y’ is the number of oxygen needed to fulfill the valence requirement of E; and ‘z’ is approx. 10-100. The catalyst is used in processes involving the combustion of organic materials and in the autothermal pyrolysis of methane and/or natural gas.

CN101485978, CN101054339, CN1792428, JP10168223 also discloses conversion of solid wastes to hydrocarbon fuels in presence of a catalyst.

The catalysts described above are however either photocatalyst/thermal catalyst that require outer source of energy to activate. Moreover, the catalyst exists as fluid catalysts requiring controlled conditions to maintain the particle size. Also, during the process the catalysts undergo degradation due to the jagged, irregular shape of the catalysts thus limiting the use of these catalysts and therefore also limiting the industrial output.

In addition, the processes described and the function of the catalysts is limited to the conversion or degradation of certain kinds of wastes, the catalysts are added along with the wastes leading to poisoning of the catalysts and thus reducing their activity and the reaction rate.

To overcome the dual problems of disposal of non-biodegradable as well as biodegradable waste material to meet the energy requirements, use of waste material as an alternative source of renewable energy is proposed to be harnessed through the present invention. Moreover, the present inventor felt a need to develop an active catalyst which can be effectively used for the conversion of waste material into hydrocarbon fuels.

In view of the above, the present invention provides improved active catalyst, which is integral to the structure, avoids the disadvantages of the prior arts, and which is cost effective, can operate optimally under experimental conditions without any degradation, for the conversion of homogenous and heterogeneous waste material into recyclable hydrocarbons. This remains the subject of the invention.

### SUMMARY OF THE INVENTION

In accordance to the approach of the present invention, there is provided an external, fixed bed, agglomerated nano catalyst composition for conversion of homogenous and heterogeneous waste material to hydrocarbon fractions.

The agglomerated nano catalyst includes the elements of the transition series comprising the ‘d-block’ in metallic or in oxide or hydroxide form either alone or mixtures thereof, rare earth elements of group IIIB including the lanthanide series, and actinide series comprising the ‘f-block’, in metallic or in oxide or hydroxide form either alone or mixtures thereof, wherein, at least one of the element of the catalytic composition exhibits variable oxidation states, optionally in combination with montmorillonite clay or its derivatives and optionally in combination with the binder.

In an aspect, the present invention provides an external, fixed bed, agglomerated nano catalyst of formula I;

AₓB_{y}O_{z}.Qₙ.(OH)ₘ

where, ‘A’ represents transition element selected from Ti, Mn, Cr, Fe, Ni, Nb, Mo, Zr, Hf, Ta, Zn, either alone or mixture thereof in metallic or oxide or as hydroxides; ‘B’ represents rare earth elements of group III B including the lanthanide series, and actinide series comprising the ‘f-block’ selected from Sc, Yt, La, Ce, Nd, Pr, Th either alone or mixture thereof in metallic or oxide or as hydroxides;
‘x’ is the number in the range of about 0-2; ‘y’ is the number in the range of about 0-2;
‘m’ is the number in the range of about 0-4; ‘n’ is the number 0, 1;
‘z’ is the number of oxygen atoms needed to fulfill the requirements of the elements possible;
‘Q’ represents montmorillonate clay or its derivatives; optionally along with an organic binder selected from Titanium Tetraflouride, ethylene glycol, ethylene glycol monomethylether (EGME), methyl cellulose, tetrafloroethylyne, poly(diallyl-dimethylammonium, L-lysine, L-proline, Phenolics, Ethenol homoPolymers; preferably Ethenol homoPolymers;
with the proviso, when ‘x’ is 0; ‘y’ is equal to 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1, optionally along with an organic binder;
with the proviso, when ‘y’ is 0; ‘x’ is equal to 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1, optionally along with an organic binder;
with the proviso, when ‘x’ and ‘y’ both are present selected from 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1 along with an organic binder.

In an aspect, the catalyst consists of 50% by weight element ‘A’ as oxide, 25% by weight element ‘B’ in metallic form and 25% by weight montmorillonate clay (Q).

In yet another aspect, the catalyst consists of 30% by weight element ‘A’ as hydroxide, 10% by weight binder and 60% by weight element ‘A’ as its oxide.

In further aspect, the catalyst composition consists of 12% by weight element ‘B’ in metallic form and 88% by weight montmorillonate clay or its derivatives (Q).

In yet another aspect, the catalyst composition consists of 6% by weight element ‘B’ in metallic form, 44% by weight montmorillonate clay or its derivatives (Q), 30% by weight element ‘A’ as oxide, 15% by weight element ‘A’ as hydroxide and 5% by weight binder.

In another aspect, the catalyst consists of nanoparticles of element ‘A’ as oxide or hydroxide. Accordingly, catalyst consists of nano metal oxide-hydroxide comprising essentially of titanium oxide and titanium hydroxide.

The catalyst type IA consists 30% by weight of titanium hydroxide, 10% by weight organic binder and 60% by weight of titanium oxide.

In another aspect, the catalyst type IB consists of 12% by weight Lanthanum and 88% by weight montmorillonate clay or its derivatives (Q).

The catalyst type IC consists of 6% by weight lanthanum in metallic form, 44% by weight montmorillonate clay or its derivatives (Q), 30% by weight titanium oxide, 15% by weight of titanium hydroxide and 5% by weight binder.

The particle size of nano catalyst is in the range of 20-100 nm, which is agglomerated to obtain granules of particle size in the range of 100 microns-500 microns. The agglomerated nano-catalyst has a specific gravity in the range of 4.2-5.0. The thickness of the catalyst bed can vary from 1 cm to 100 cms or beyond.

In another aspect, the catalyst acts as a pyro-catalyst at a temperature in the range of 10-80° C. and can be effective even in the temperature range of 100°-500° C.

In yet another aspect, the present invention provides a process for the preparation of the nano agglomerated catalyst.

The catalyst of the present invention is used for the conversion of homogenous and heterogeneous waste materials selected from biomass, plastic wastes, rubber wastes, municipal solid sewage waste, electronic waste, petroleum wastes, edible and non-edible oil cakes, edible and non-edible oil seeds, animal wastes, vegetable fats, animal fats or a combination thereof into usable combustible fuel. The combustible fuels are either in the form of a gas, liquid fuel or a solid fuel (carbon) or a combination of the three phases of gas, liquid and solid carbon.

### DESCRIPTION OF DRAWINGS

FIG. 1(a) and FIG. 1(b) depict the general process for the preparation of agglomerated nano catalyst.

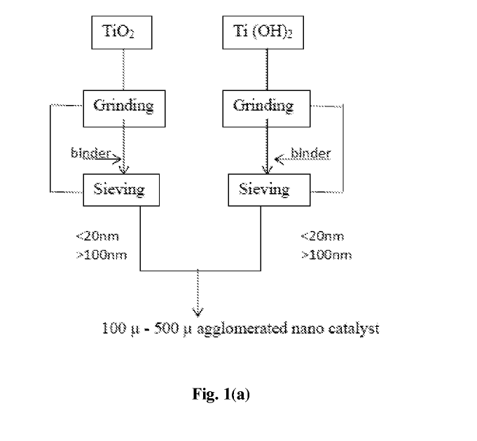

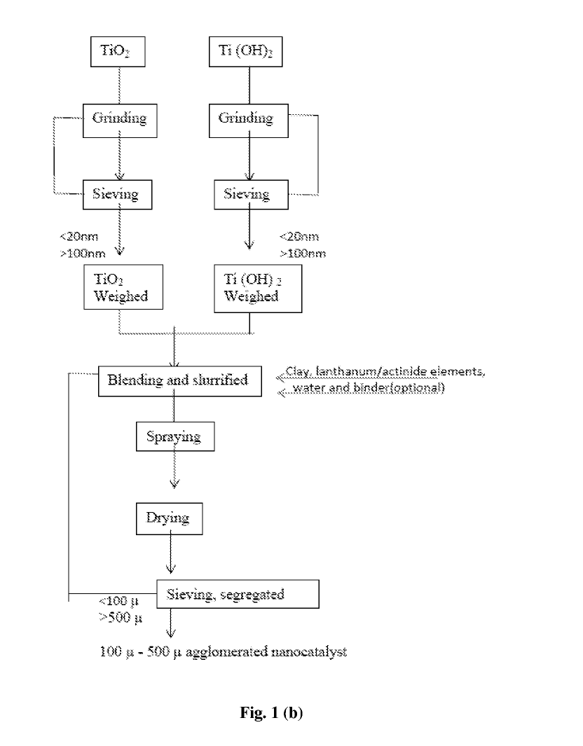

### DETAILED DESCRIPTION OF THE INVENTION

The invention will now be described in detail in connection with certain preferred and optional embodiments, so that various aspects thereof may be more fully understood and appreciated.

The present invention provides an external, fixed bed, single or multilayered agglomerated nano catalyst comprising of transition/rare earth elements/inner transition metal of actinide series, either alone or combination thereof for the pyrolytic conversion of homogenous and heterogeneous waste material into hydrocarbon fractions and carbon. Accordingly, the single or multilayered agglomerated nano catalyst includes the elements of the transition series comprising the ‘d-block’ in metallic or in oxide or as hydroxide form either alone or mixtures thereof, rare earth elements of group III B including the lanthanide series, and actinide series comprising the ‘f-block’, in metallic or in oxide or hydroxide form either alone or mixtures thereof, wherein, at least one of the element of the catalytic composition exhibits variable oxidation states, optionally in combination with montmorillonate clay or its derivatives and optionally in combination with the binder.

As used herein, the term ‘catalyst’ or ‘catalyst composition’ means and refers to the composition consisting of elements of transition series comprising the ‘d-block’ in metallic or in oxide or as hydroxide form either alone or mixtures thereof, rare earth elements of group III B including the lanthanide series, and actinide series comprising the ‘f-block’, in metallic or in oxide or hydroxide form either alone or mixtures thereof that exhibits variable oxidation states, optionally in combination with montmorillonate clay or its derivatives and optionally in combination with the binder.

In an embodiment, the fixed bed, external, single or multilayered agglomerated nano catalyst of the present invention is represented by a formula I;

AₓB_{y}O_{z}.Qₙ.(OH)ₘ

where, ‘A’ represents transition element selected from Ti, Mn, Cr, Fe, Ni, Nb, Mo, Zr, Hf, Ta, Zn, either alone or mixture thereof in metallic or oxide or as hydroxides; ‘B’ represents rare earth elements of group III B including the lanthanide series, and actinide series comprising the ‘f-block’ selected from Sc, Yt, La, Ce, Nd, Pr, Th either alone or mixtures thereof in metallic or oxide or as hydroxides;
‘x’ is the number in the range of about 0-2; ‘y’ is the number in the range of about 0-2;
‘m’ is the number in the range of about 0-4; ‘n’ is the number 0, 1;
‘z’ is the number of oxygen atoms needed to fulfill the requirements of the elements possible;
‘Q’ represents montmorillonate clay or its derivatives; optionally along with an organic binder selected from Titanium Tetraflouride, ethylene glycol, ethylene glycol monomethylether (EGME), methyl cellulose, tetrafloroethylyne, poly(diallyl-dimethylammonium, L-lysine, L-proline, Phenolics, Ethenol homoPolymers; preferably Ethenol homoPolymers;
with the proviso, when ‘x’ is 0; ‘y’ is equal to 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1, optionally along with an organic binder;
with the proviso, when ‘y’ is 0; ‘x’ is equal to 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1, optionally along with an organic binder;
with the proviso, when ‘x’ and ‘y’ both are present selected from 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1 along with an organic binder.

The catalyst of the present invention comprises ‘A’ in metallic or in oxide or hydroxide form in the range of 10-65% by weight; ‘B’ in metallic or in oxide or hydroxide form in the range of 5-25% by weight; ‘Q’ in the range of 30-90% by weight and optionally the organic binder in the range of 5-12% by weight either alone or in combination thereof.

In another embodiment, the catalyst consists of 50% by weight element ‘A’ as oxide, 25% by weight element ‘B’ in metallic form and 25% by weight montmorillonate clay (Q).

In yet another embodiment, the catalyst consists of 30% by weight element ‘A’ as hydroxide, 10% by weight binder and 60% by weight element ‘A’ as its oxide.

In further embodiment, the catalyst composition consists of 12% by weight element ‘B’ in metallic form and 88% by weight montmorillonate clay or its derivatives (Q).

In yet another embodiment, the catalyst composition consists of 6% by weight element ‘B’ in metallic form, 44% by weight montmorillonate clay or its derivatives (Q), 30% by weight element ‘A’ as oxide, 15% by weight element ‘A’ as hydroxide and 5% by weight binder.

In another embodiment, the catalyst consists of nanoparticles of element ‘A’ as oxide or hydroxide. Accordingly, catalyst consists of nano metal oxide-hydroxide comprising essentially of titanium oxide and titanium hydroxide.

The catalyst type IA consists 30% by weight of titanium hydroxide, 10% by weight organic binder, ethenol homopolymer and 60% by weight of titanium oxide.

In another embodiment, the catalyst type IB consists of 12% by weight Lanthanum and 88% by weight montmorillonate clay or its derivatives (Q).

The catalyst type IC consists of 6% by weight lanthanum in metallic form, 44% by weight montmorillonate clay or its derivatives (Q), 30% by weight titanium oxide, 15% by weight of titanium hydroxide and 5% by weight of organic binder ethenol homopolymer.

The nano particle size of the catalyst is in the range of 20-100 nm, which is agglomerated to obtain granules of particle size in the range of 100-500 microns. The agglomerated nano-catalyst has a specific gravity in the range of 4.2-5.0. The single/multilayered agglomerated nano catalyst acts as a pyro catalyst at a temperature in the range of 10-80° C. and can be effective even in the temperature range of 100°-500° C., preferably at a temperature of 30° C. to 90° C. and de-polymerizes the high molecular weight molecules of polymers made from hydrocarbons/petrochemicals.

The thickness of the catalyst column dictates the output product composition. The thicker the column, the lighter fractions or combustible gases in the output and the thinner the column width, the higher viscosity fuels will be derived. Thus, the catalyst column thickness is a critical function in the process of conversion of waste material into hydrocarbon fuels and solid carbon. The thickness of the catalyst bed can vary from 1 cm to 100 cms or beyond.

The surface area per unit weight is an important consideration when catalysts are used in the solid state. The said catalyst may have a surface area of 35-250 sq. mt/gm. The catalyst of type IA has a surface area of 160 to 250 sq. mt/gm, 35 to 40 sq. mt/gm for IB and 90 to 120 sq. mt per gram for IC catalyst.

In another embodiment, the present invention provides a process for the preparation of the agglomerated nano catalyst. According to the process, the nano particles of the elements either in metallic or oxide or hydroxide form either alone or combination thereof is prepared by a process known in the art.

In an aspect, the process for the preparation of agglomerated nanocatalyst comprises;
a. subjecting the nanoparticles of the elements either in metallic or oxide or hydroxide form either alone or combination thereof to cryogenic grinding in the temperature range of −40° C. to −50° C. followed by sieving and segregating to obtain nano particles of the size in the range of 20-100 nm;
b. recycling the nanoparticles of particle size less than 20 nm and greater than 100 nm obtained after segregation to grinding of step (a);
c. adding a binder or montmorillonite clay to the nano particles of size in the range of 20-100 nm of step (a) and blending to form a slurry;
d. spraying the slurry into a fine spray through nozzle onto the belt, drying, sieving, segregating to obtain desired agglomerated nanocatalyst with the particle size in the range of 100-500 microns; and
e. recycling the particles of particle size less than 100 microns and greater than 500 microns obtained in step (d) to step (c).

In another aspect, the process for the preparation of agglomerated nanocatalyst comprises;
a. adding element selected from the lanthanide or actinide series or a transition metal to the weighed nanoparticles with particle size in the range of 20-100 nm followed by addition of water, montmorillointe clay or its derivatives, optionally a binder and blending to form a slurry;
b. spraying the slurry into a fine spray through nozzle onto the belt, drying, sieving, segregating to obtain desired agglomerated nanocatalyst with the particle size in the range of 100-500 microns; and
c. recycling the particles of particle size less than 50 microns and greater than 100 microns obtained in step (b) to step (a).

The grinding is carried out at cryogenic temperature in the range of −40° C. to −50° C. which leads to obtain finer grain structures and more rapid grain refinement.

Accordingly, the process for preparation of catalyst type IA includes;
a. subjecting the nanoparticles of 30% by weight of titanium hydroxide, 60% by weight of titanium oxide to cryogenic grinding at a temperature in the range of −40° C. to −50° C. followed by sieving and segregating to obtain nano particles of the size in the range of 20-100 nm;
b. recycling the nanoparticles of particle size less than 20 nm and greater than 100 nm obtained after segregation to grinding of step (a);
c. adding 10% by weight of ethenol homopolymer as a binder and blending to form a slurry;
d. spraying the slurry into a fine spray through nozzle onto the belt, drying, sieving, segregating to obtain desired agglomerated nanocatalyst type IA with the particle size in the range of 100-500 microns; and
e. recycling the particles of particle size less than 100 microns and greater than 500 microns obtained in step (d) to step (c).

The process for preparation of catalyst type IB includes;
a. subjecting the nanoparticles of particles of 12% by weight of lanthanum to cryogenic grinding at a temperature in the range of −40° C. to −50° C. followed by sieving and segregating to obtain nano particles of the size in the range of 20-100 nm;
b. recycling the nanoparticles of particle size less than 20 nm and greater than 100 nm obtained after segregation to grinding of step (a);
c. adding 88% by weight of montmorillonite clay and blending to form a slurry;
d. spraying the slurry into a fine spray through nozzle onto the belt, drying, sieving, segregating to obtain desired agglomerated nanocatalyst type IB with the particle size in the range of 100-500 microns; and
e. recycling the particles of particle size less than 100 microns and greater than 500 microns obtained in step (d) to step (c).

The process for preparation of catalyst type IC includes;
a. adding 6% by weight of lanthanum, 44% by weight of montmorillonite clay, 5% by weight of ethenol homopolymer as binder and water to the weighed mixture of titanium oxide (30% by weight) and titanium hydroxide (15% by weight) with particle size of 20-100 nm and blending to form a slurry;
b. spraying the slurry into a fine spray through nozzle onto the belt, drying, sieving, segregating to obtain desired agglomerated nano catalyst type IC with the particle size in the range of 100-500 microns; and
c. recycling the particles of particle size less than 100 microns and greater than 500 microns obtained in step (b) to step (a).

The drying is carried out using Infra-red or dried using indirectly heated rotary kiln at calcined temperature in the range of 400-450° C. to obtain agglomerated nano catalyst.

The catalyst of the current invention, in agglomerated nano particulate form, is packed inside a cylindrical steel column and can have more than one layer of different metal oxide, metal hydroxide and/or pure metals and/or catalyst combinations. Advantageously, the column is a fixed bed reactor thereby allowing reuse of the catalyst.

In a preferred embodiment, the catalyst of the current invention is not added to the processed input material but the vapors from the processed waste materials are passed through the catalyst column that is sealed at both the ends with one inlet and one outlet opening allowing for the receipt of vapors from the reactor and to discharge the de-polymerized, reformed gases through the outlet.

The said catalyst of the present invention is a redox catalyst and is used as ‘external or contact catalyst’ which is in a different phase from the reactants i.e waste material. The catalyst forms a single or multilayered fixed bed which has a capability of adsorbing molecular gases onto their surfaces thus acting as excellent potential catalysts.

Further, the catalyst of the present invention can bring about various vapor phase decomposition or conversion of the waste material, such as de-polymerization of high molecular weight long chain polymers to monomers, reduction of hazardous chemical/oxides, cracking of waste plastics of polypropylene, polyethylene, polystyrene and other high molecular weight plastics into hydrocarbon fractions etc. The feed material can be a mix of different plastics mixed in any ratio.

The homogenous and heterogeneous waste materials that can be converted into usable combustible fuel using the present catalyst is selected from biomass, plastic wastes, rubber wastes, municipal sewage waste, electronic waste, petroleum wastes, oil cakes, animal wastes, vegetable fats, animal fats or a combination thereof.

The catalyst of the current invention is used to convert waste materials as mentioned above into usable combustible fuels either in the form of a gas, liquid fuel or a solid fuel (carbon) or a combination of the three phases of gas, liquid and solid carbon.

The catalyst which acts as a pyro-catalyst can de-polymerize the high molecular weight molecules of polymers made from hydrocarbons/petrochemicals. The catalyst dissociates the bonds of Hydrogen and Carbon to form Hydrogen, Low molecular weight Hydrocarbons. The catalyst involves in the reforming of hydrocarbon molecular chains having a molecular structure similar to liquid fuels such as Gasoline, Diesel, Kerosene and LSHS (Low sulfur heavy stock)/LDO (Light diesel oil).

The evolved vapors are condensed to collect gas and liquid products. The evolved gas consists of mixed factions of C1-05 hydrocarbons such as methane, ethane, ethylene, propane, propylene, iso-butane, n-butane, unsaturated factions in the C1-05 range and the liquid fraction of C6-C24 carbon atoms etc. Product yield slightly varies depending upon the raw material used.

The present invention provides a method to convert homogenous and heterogeneous waste materials into hydrocarbon fuel fractions and carbon, said method comprising vapor phase decomposition of homogenous and/or heterogeneous waste material into hydrocarbon fuel and carbon using external, fixed bed, agglomerated nano catalyst of formula I.

Further, the present invention provides the use of external, fixed bed, agglomerated nano catalyst of formula I for the conversion of homogenous and heterogeneous waste materials into hydrocarbon fuel fractions and carbon.

The conversion of homogenous and heterogeneous waste material into usable combustible fuels, the liquid properties, and the yields from various feed stock using the catalyst of the present invention is given below in Tables 1, 2 and 3:

TABLE 1
Analysis of the liquid product:

| | Carbon | Corresponds | Quantity (wt %) |
|---|---|---|---|
| Sr. No. | Number | to (Fuel) | (app.) |
| 1 | Upto C10 | Gasoline | 34.0 |
| 2 | C10 to C13 | Kerosene | 27.0 |
| 3 | C13 to C20 | Diesel | 23.0 |
| 4 | C20 and above | Fuel Oil | 16.0 |

TABLE 2
The liquid Fuel Properties:

| Parameter | Value | UOM |
|---|---|---|
| Density @30 deg C. | 0.80-0.86 | |
| Viscosity | 2.9-4.5 | CSt |
| Initial Boiling Point | 130 | Deg C. |
| Final Boiling Point | 340 | Deg C. |
| Gross Calorific Value | 10800 | k · Cal/Kg |

TABLE 3
Yields from various Feedstocks
Experimental data on Yields from various Feed Stocks

| Feed Stock | % Oil | % Gas | % Carbon |
|---|---|---|---|
| Plastics | | | |
| PE | 80% | 6% | 14% |
| PP | 77% | 15% | 7% |
| ABS | 72% | 18% | 10% |
| Car Fluff | 20% | 28% | 52% |
| e-waste plastics | 55% | 20% | 25% |
| Mixed Plastics | | | |
| Biomass | | | |
| Deoiled Cake | 40% | 8% | 52% |
| Cashew Kernel | 62% | 12% | 26% |
| Empty Palm Fruit Bunch | 36% | 34% | 30% |
| Jathropha seeds | 44% | 16% | 40% |
| Bamboo | 4% | 42% | 54% |
| Wood chips | 27% | 33% | 40% |
| Rice Husk | 1% | 49% | 50% |
| Chicken Manure | 48% | 5% | 47% |
| Municipal Solid Waste | 6% | 13% | 78% |
| Refinery Waste | | | |
| Tank Botttom Sludge | 74% | 11% | 15% |
| Vacuum Residue | 38% | 8% | 54% |
| Rubber | | | |
| Tyres | 40% | 15% | 45% |
| Rubber Parts | 48% | 24% | 28% |

The catalysts of the current invention in the various embodiments mentioned are subjected to catalytic testing for various feed stocks as given below:
(1): The catalyst of type IA and IB are subjected to polycrack testing with Municipal Solid waste (MSW). The reaction conditions and the average conversion and the recovery of fuel are given in Table 4 below:

TABLE 4

| Quantity | 2.5-38 kgs |
|---|---|
| Temperature | 22-450 C. |
| Average conversion to oil (Kgs) | 2.221 |
| Avg. conversion to gas (Kgs) | 4.656 |
| Avg. conversion to gas (Kgs) | 10.331 |
| Recovery of oil (%) | 8.955 |
| Recovery of gas (%) | 17.14 |
| Recovery of carbon (%) | 38.24 |
| Recovery of water (%) | 35.83 |

(2) Polycrack testing with various feed material using catalysts of type IA, IB and IC are given below in examples 5-7:
(3) Polycrack testing with various plastics using catalysts of type IA, IB and IC are given below in examples 5-7:

The polycrack of various waste material is carried at temperature in the range of 10-40 C and further the pyrolytic cracking is carried upto 460 C with good conversion rate and of fuel gases.

### Salient Features:

The present catalyst does not require external source of energy and can operate effectively under pyrolytic conditions without attrition.
Is cost effective, has high surface area due to nano size particles, exhibits excellent catalytic activity.
Can convert both homogenous and heterogeneous waste material to hydrocarbon fractions with high conversion rate.
Can operate at ambient temperature to 500 deg C. and more and thus very flexible in the gas temperature and does not require activation by thermal or photon sources.
Highly tolerant to moisture in the gases and will not disintegrate under steam and moisture conditions.
Does not release residues into liquid and gas fuel outputs making, producing “catalyst contamination free” fuels.
De-polymerizes, molecular splitting, re-combination of basic hydrocarbon molecules middle distillate level hydrocarbon chains, all under one single pass and on contact.
Does not require high contact time for reactions to happen and acts as a single pass on contact conversion catalyst.
Recyclable and reusable a number of times
Land-fillable material and does not cause pollution and leaching of contaminants trapped in the catalyst.

The following examples, which include preferred embodiments, will serve to illustrate the practice of this invention, it being understood that the particulars shown are by way of examples and for purpose of illustrative discussion of preferred embodiments of the invention only and are not limiting the scope of the invention.

### EXAMPLES

### Example 1

### Preparation of Catalyst of Type IA

Nanoparticles of 30% by weight of titanium hydroxide, 60% by weight of titanium oxide are subjected to cryogenic grinding at a temperature of −40° C. to −50° C. The pulverized particles are sieved and segregated to obtain nano particles of the size in the range of 20-100 nm. The nanoparticles of particle size less than 20 nm and greater than 100 nm obtained after segregation are recycled to perform cryogenic grinding. Further, 10% by weight of ethenol homopolymer as a binder is added to the fine particle mixture so obtained and blended to form a slurry. The slurry is sprayed into a fine spray through nozzle onto the belt followed by infra-red drying. The particles are sieved and segregated to the desired agglomerated nanocatalyst type IA with the particle size in the range of 100-500 microns. The particles of particle size less than 100 microns and greater than 500 microns obtained after segregation are recycled. Surface area 160-250 sq.mt/gm

### Example 2

### Preparation of Catalyst of Type IB

Nanoparticles of 12% by weight of lanthanum is subjected to cryogenic grinding at a temperature of −40° C. to −50° C. The so formed pulverized particles are sieved and segregated to obtain nano particles of the size in the range of 20-100 nm. The nanoparticles of particle size less than 20 nm and greater than 100 nm obtained after segregation are recycled to perform cryogenic grinding. 88% by weight of montmorillonite clay is further added to the fine particle mixture so obtained and blended to form a slurry. The slurry is sprayed into a fine spray through nozzle onto the belt followed by infra-red drying. The particles are sieved and segregated the desired agglomerated nanocatalyst type IB with the particle size in the range of 100-500 microns. The particles of particle size less than 100 microns and greater than 500 microns obtained after segregation are recycled. Surface area—35-40 sq.mt/gm

### Example 3

### Preparation of Catalyst of Type IC

To the weighed mixture of 30% by weight of titanium oxide and 15% by weight of titanium hydroxide (nano particle size of 20-100 nm) is added water and a mixture of 6% by weight of lanthanum, 44% by weight of montmorillonite clay, 5% by weight of ethenol homopolymer as a binder. The mixture is blended to form a slurry. The slurry is sprayed into a fine spray through nozzle onto the belt followed by Infra-red drying followed by sieving and segregating the desired agglomerated nanocatalyst type IB with the particle size in the range of 100-500 microns. The particles of particle size less than 100 microns and greater than 500 microns obtained after segregation are recycled. Surface area: 90-120 sq.mt/gm.

### Example 4

### Polycrack Testing with Municipal Solid Waste (MSW) Using Catalyst of Type IA and IB

| | Feed | Qty | Start Temp. | Final Temp. | Conversion & Recovery | | | | Percentage Recovery | | | |
|---|---|---|---|---|---|---|---|---|---|---|---|---|
| | Material | Polycrack Testing with Municipal Solid Waste (MSW) | | | | | Carbon/ | | | | Carbon/ | |
| Catalyst | Feed | | | | Oil | Gas | Residue | | Oil | Gas | Residue | Water |
| Catlalyst | Material | Kgs | Deg C. | Deg C. | Kgs | Kgs | Kgs | Water | % | % | % | % |
| IB | MSW | 26.50 | 29 | 400 | 2.7750 | 2.9500 | 8.3500 | 12.4250 | 10.47% | 11.13% | 31.51% | 46.89% |
| IB | MSW | 29.30 | 28 | 400 | 0.1250 | 4.1750 | 7.3000 | 17.7000 | 0.43% | 14.25% | 24.91% | 60.41% |
| IB | MSW | 37.20 | 32 | 425 | 1.8500 | 9.9500 | 17.4000 | 8.0000 | 4.97% | 26.75% | 46.77% | 21.51% |
| IB | MSW | 26.00 | 38 | 404 | 3.5000 | 4.4000 | 7.1000 | 11.0000 | 13.46% | 16.92% | 27.31% | 42.31% |
| IA | MSW | 16.35 | 30 | 400 | 1.2000 | 1.4500 | 6.7000 | 7.0000 | 7.34% | 8.87% | 40.98% | 42.81% |
| IB | MSW | 24.15 | 37 | 400 | 3.3000 | 5.9000 | 8.6500 | 6.3000 | 13.66% | 24.43% | 35.82% | 26.09% |
| IA | MSW | 36.15 | 35 | 440 | 5.4000 | 10.2500 | 13.3000 | 7.2000 | 14.94% | 28.35% | 36.79% | 19.92% |
| IB | MSW | 25.15 | 39 | 400 | 0.5500 | 4.5500 | 9.6000 | 10.4500 | 2.19% | 18.09% | 38.17% | 41.55% |
| IB | MSW | 25.15 | 34 | 400 | 0.5000 | 4.5500 | 9.6000 | 10.4500 | 1.99% | 18.09% | 38.17% | 41.55% |
| IB | MSW | 21.80 | 41 | 403 | 0.4000 | 2.4500 | 7.3000 | 11.6500 | 1.83% | 11.24% | 33.49% | 53.44% |
| IB | MSW | 21.90 | 41 | 418 | 0.1000 | 7.0500 | 6.5000 | 8.2500 | 0.46% | 32.19% | 29.68% | 37.67% |
| IB | MSW | 33.60 | 34 | 410 | 3.4200 | 4.3700 | 18.1100 | 7.7000 | 10.18% | 13.01% | 53.90% | 22.92% |
| IB | MSW | 33.00 | 32 | 400 | 4.2000 | 3.0000 | 10.5000 | 15.3000 | 12.73% | 9.09% | 31.82% | 46.36% |
| IA | MSW | 33.60 | 44 | 400 | 5.4500 | 4.5000 | 23.6500 | 0.0000 | 16.22% | 13.39% | 70.39% | 0.00% |
| IB | MSW | 2.65 | 22 | 450 | 0.5500 | 0.3000 | 0.9000 | 0.9000 | 20.75% | 11.32% | 33.96% | 33.96% |
| Ave | | 26.167 | | | 2.221 | 4.656 | 10.331 | 8.955 | 8.77% | 17.14% | 38.24% | 35.83% |

### Example 5

### Polycrack Testing with Various Feed Material Using Catalyst of Type IA and IC

| | | | | | Conversion & Recovery | | | | Percentage Recovery | | | |
|---|---|---|---|---|---|---|---|---|---|---|---|---|
| | | | Start | Final | | | Carbon/ | | | | Carbon/ | |
| | | Qty | Temp. | Temp. | Oil | Gas | Residue | | Oil | Gas | Residue | Water |
| Catalyst | Feed Material | Kgs | Deg C. | Deg C. | Kgs | Kgs | Kgs | Water | % | % | % | % |
| IA | Paint Sludge | 2.00 | 44 | 450 | 0.925 | 0.18 | 0.9 | 0 | 46.25% | 8.75% | 45.00% | 0.00% |
| IA | Paint Sludge | 2.00 | 28 | 450 | 0.349 | 0.35 | 0.85 | 0.451 | 17.45% | 17.50% | 42.50% | 22.55% |
| IC | JCBL paint sludge | 1.72 | 32 | 450 | 0.32 | 0.16 | 1.24 | 0 | 18.60% | 9.30% | 72.09% | 0.00% |
| IC | Car Fluff | 1.944 | 30 | 450 | 0.36 | 0.554 | 1.03 | 0 | 18.52% | 28.50% | 52.98% | 0.00% |
| IC | Car Fluff | 1.944 | 30 | 450 | 0.357 | 0.557 | 1.03 | 0 | 18.36% | 28.65% | 52.98% | 0.00% |
| IC | Car Fluff | 2 | 30 | 450 | 0.5 | 0.44 | 1.06 | 0 | 25.00% | 22.00% | 53.00% | 0.00% |
| IC | Car Fluff | 2 | 30 | 450 | 0.52 | 0.42 | 1.06 | 0 | 26.00% | 21.00% | 53.00% | 0.00% |
| IC | Car Fluff | 2.1 | 30 | 450 | 0.218 | 0.682 | 1.2 | 0 | 10.38% | 32.48% | 57.14% | 0.00% |
| IC | Erzberg | 2 | 30 | 450 | 0.84 | 0.46 | 0.7 | 0 | 42.00% | 23.00% | 35.00% | 0.00% |
| IC | Erzberg | 1.6 | 30 | 450 | 0.12 | 0.072 | 1.408 | 0 | 7.50% | 4.50% | 88.00% | 0.00% |
| IC | Fronleiten | 1 | 30 | 450 | 0.296 | 0.704 | 0 | 0 | 29.60% | 70.40% | 0.00% | 0.00% |
| IC | Nemetz prduktions | 0.58 | 30 | 450 | 0.332 | 0.048 | 0.2 | 0 | 57.24% | 8.28% | 34.48% | 0.00% |
| | abfalle konnenberg | | | | | | | | | | | |
| IC | Zeefoveloop | 2 | 30 | 450 | 0.69 | 0.736 | 0.574 | 0 | 34.50% | 36.80% | 28.70% | 0.00% |
| IC | Zeefoveloop | 2.05 | 30 | 450 | 1.615 | 0.005 | 0.43 | 0 | 78.78% | 0.24% | 20.98% | 0.00% |

### Example 6

### Polycrack Testing with Various Feed Material Using Catalyst of Type IA and IC

| | | | | | Conversion & Recovery | | | | Percentage Recovery | | | |
|---|---|---|---|---|---|---|---|---|---|---|---|---|
| | | | Start | Final | | | Carbon/ | | | | Carbon/ | |
| | | Qty | Temp. | Temp. | Oil | Gas | Residue | | Oil | Gas | Residue | Water |
| Catalyst | Feed Material | Kgs | Deg C. | Deg C. | Kgs | Kgs | Kgs | Water | % | % | % | % |
| IA | Algae | 1.50 | 31 | 450 | 0.25 | 0.30 | 0.45 | 0.5 | 16.67% | 20.00% | 30.00% | 33.33% |
| A | Algae | 3.00 | 45 | 450 | 0.2 | 2.15 | 0.65 | 2 | 6.67% | 71.67% | 21.67% | 66.67% |
| A | Algae | 1.00 | 27 | 450 | 0.175 | 0.33 | 0.5 | 0 | 17.50% | 32.50% | 50.00% | 0.00% |
| A | Bamboo + Plastics | 3.50 | 20 | 450 | 1.36 | 0.59 | 0.95 | 0.6 | 38.86% | 16.86% | 27.14% | 17.14% |
| | (2.0 + 1.5 kgs) | | | | | | | | | | | |
| A | Bio-Digestor Slduge | 2.45 | 22 | 450 | 0 | 0.3 | 0.45 | 1.7 | 0.00% | 12.24% | 18.37% | 69.39% |
| A | Biomass | 1.70 | 19 | 450 | 0.1 | 0.45 | 0.35 | 0.8 | 5.88% | 26.47% | 20.59% | 47.06% |
| A | Biomass | 2.00 | 26 | 450 | 0.425 | 0.6 | 0.7 | 0.275 | 21.25% | 30.00% | 35.00% | 13.75% |
| A | Coffe skins | 1.15 | 28 | 450 | 0 | 0.15 | 0.15 | 0.85 | 0.00% | 13.04% | 13.04% | 73.91% |
| A | Molasses effluent | 2.75 | 22 | 450 | 0 | 0.275 | 0.40 | 2.075 | 0.00% | 10.00% | 14.55% | 75.45% |
| A | Multi feed | 2.00 | 20 | 450 | 1.1 | 0.25 | 0.65 | 0 | 55.00% | 12.50% | 32.50% | 0.00% |
| A | Palm EFB | 1.25 | 24 | 500 | 0.45 | 0.5 | 0.3 | 0 | 36.00% | 40.00% | 24.00% | 0.00% |
| A | Palm EFB | 0.33 | 22 | 450 | 0.084 | 0.096 | 0.15 | 0 | 25.45% | 29.09% | 45.45% | 0.00% |
| IA | Palm EFB | 1.00 | 24 | 350 | 0.3 | 0.5 | 0.2 | | 30.00% | 50.00% | 20.00% | 0.00% |
| IA | Sugar Cane Bagasse | 1.10 | 45 | 450 | 0.08 | 0.07 | 0.95 | 0 | 7.27% | 6.36% | 86.36% | 0.00% |
| IA | wood Chips | 2.00 | 21 | 450 | 0.725 | 0.58 | 0.7 | 0 | 36.25% | 28.75% | 35.00% | 0.00% |
| IC | Cashew shell oil | 3 | 30 | 450 | 1.84 | 0.62 | 0.54 | 0 | 61.33% | 20.67% | 18.00% | 0.00% |
| IC | Cashew shell oil | 3 | 30 | 450 | 1.878 | 0.642 | 0.48 | 0 | 62.60% | 21.40% | 16.00% | 0.00% |
| IC | Dried fibre after autoclave | 1.3 | 30 | 450 | 0.227 | 0.445 | 0.628 | 0 | 17.46% | 34.23% | 48.31% | 0.00% |
| IC | dry chicken manure | 2.5 | 30 | 450 | 1.21 | 0.118 | 1.172 | 0 | 48.40% | 4.72% | 46.88% | 0.00% |
| IC | Dry chicken manure | 2.68 | 30 | 450 | 0.599 | 1.127 | 0.954 | 0 | 22.35% | 42.05% | 35.60% | 0.00% |
| IC | EFB | 2 | 30 | 450 | 0.15 | 1.25 | 0.6 | 0 | 7.50% | 62.50% | 30.00% | 0.00% |
| IC | EFB | 2 | 30 | 450 | 0.3 | 1.6 | 0.1 | 0 | 15.00% | 80.00% | 5.00% | 0.00% |
| IC | Fiber | 3 | 30 | 450 | 1.756 | 0.364 | 0.88 | 0 | 58.53% | 12.13% | 29.33% | 0.00% |
| IC | Fibre sample | 2.1 | 30 | 450 | 0.96 | 0.39 | 0.75 | 0 | 45.71% | 18.57% | 35.71% | 0.00% |
| IC | Kappa/H2o (PULPER | 2 | 30 | 450 | 1 | 0.59 | 0.41 | 0 | 50.00% | 29.50% | 20.50% | 0.00% |
| | material) | | | | | | | | | | | |
| IC | Krantenpapier | 0.51 | 30 | 450 | 0 | 0.51 | 0 | 0 | 0.00% | 100.00% | 0.00% | 0.00% |
| IC | Paper mill samples | 1.6 | 30 | 450 | 0.08 | 0.02 | 1.5 | 0 | 5.00% | 1.25% | 93.75% | 0.00% |
| IC | POME | 2 | 30 | 450 | 0.25 | 1.69 | 0.06 | 0 | 12.50% | 84.50% | 3.00% | 0.00% |
| IC | Rice paddy husk/braked | 2 | 30 | 450 | 0.01 | 1.48 | 0.51 | 0 | 0.50% | 74.00% | 25.50% | 0.00% |
| | rice | | | | | | | | | | | |
| IC | wood chips | 0.8 | 30 | 450 | 0.217 | 0.267 | 0.316 | 0 | 27.13% | 33.38% | 39.50% | 0.00% |
| IC | wood chips | 1.5 | 30 | 450 | 0.243 | 0 | 1.257 | 0 | 16.20% | 0.00% | 83.80% | 0.00% |

### Example 7

### Polycrack Testing of Sludge Using Catalyst of Type IA, IB and IC

| | | | | | Conversion & Recovery | | | | Percentage Recovery | | | |
|---|---|---|---|---|---|---|---|---|---|---|---|---|
| | | | Start | Final | | | Carbon/ | | | | Carbon/ | |
| | | Qty | Tem [symbol] | Tem [symbol] | Oil | Gas | Residue | | Oil | Gas | Residue | Water |
| Catalyst | Feed Material | Kgs | Deg C. | Deg C. | Kgs | Kgs | Kgs | Water | % | % | % | % |
| IA | Sludge | 4.40 | 26 | 450 | 2.9 | 0.35 | 0.55 | 0.6 | 65.91% | 7.95% | 12.50% | 13.64% |
| IA | Sludge | 3.70 | 27 | 450 | 1.8 | 0.2 | 1 | 0.7 | 48.65% | 5.41% | 27.03% | 18.92% |
| IA | Sludge | 5.60 | 25 | 450 | 1.87 | 0.18 | 3.55 | 0 | 33.39% | 3.21% | 63.39% | 0.00% |
| IA | Sludge | 4.10 | 25 | 400 | 1.1 | 0.5 | 2.5 | 0 | 26.83% | 12.20% | 60.98% | 0.00% |
| IA | Sludge | 2.30 | 24 | 450 | 1.15 | 0.375 | 0.5 | 0.275 | 50.00% | 16.30% | 21.74% | 11.96% |
| IA | Sludge | 3.00 | 21 | 450 | 1.15 | 0.35 | 1.5 | 0 | 38.33% | 11.67% | 50.00% | 0.00% |
| IA | Sludge | 43.50 | 31 | 440 | 21 | 19.65 | 2.85 | | 48% | 45% | 7% | 0% |
| IB | Crude Oil Sludge | 9.00 | 29 | 450 | 4.35 | 0.425 | 1.55 | 2.675 | 48% | 5% | 17% | 30% |
| IB | Sludge | 5.40 | 27 | 450 | 2.7 | 0.5 | 1.8 | 0.4 | 50.00% | 9.26% | 33.33% | 7.41% |
| IB | Sludge | 4.00 | 21 | 400 | 1.2 | 0.325 | 1.875 | 0.6 | 30.00% | 8.13% | 46.88% | 15.00% |
| IB | Sludge | 2.00 | 23 | 400 | 0.475 | 0.125 | 1.15 | 0.25 | 23.75% | 6.25% | 57.50% | 12.50% |
| IB | Sludge | 27.00 | 28 | 400 | 11.9 | 1.6 | 12.75 | 0.75 | 44.07% | 5.93% | 47.22% | 2.78% |
| IB | Sludge | 5.10 | 24 | 450 | 3.125 | 0.375 | 0.7 | 0.9 | 61.27% | 7.35% | 13.73% | 17.65% |
| IB | Tar | 2.20 | 22 | 450 | 0.75 | 0.3 | 1.15 | 0 | 34.09% | 13.64% | 52.27% | 0.00% |
| IB | Sludge | 5.65 | 30 | 440 | 1.5 | 0.35 | 2.05 | 1.75 | 27% | 6% | 36% | 31% |
| IB | Sludge | 5.65 | 30 | 450 | 1.5 | 0.4 | 2 | 1.75 | 26.55% | 7.08% | 35.40% | 30.97% |
| IB | Sludge | 43.50 | 34 | 400 | 18 | 2.85 | 19.65 | 3 | 41.38% | 6.55% | 45.17% | 6.90% |
| IB | Sludge | 60.00 | 28 | 400 | 26.155 | 9.645 | 24.2 | 0 | 43.59% | 16.08% | 40.33% | 0.00% |
| IB | Sludge | 2.50 | 22 | 450 | 0.8 | 0.225 | 0.85 | 0.625 | 32.00% | 9.00% | 34.00% | 25.00% |
| IC | Tank bottom sludge | 2 | 30 | 450 | 1.308 | 0.352 | 0.34 | 0 | 65.40% | 17.60% | 17.00% | 0.00% |
| IC | Sludge | 2.28 | 30 | 450 | 1.682 | 0.256 | 0.342 | 0 | 73.77% | 11.23% | 15.00% | 0.00% |
| IC | TAR | 3.4 | 30 | 450 | 0.016 | 0.184 | 3.2 | 0 | 0.47% | 5.41% | 94.12% | 0.00% |

[symbol]

indicates data missing or illegible when filed

### Example 8

### Polycrack Testing of Plastics Using Catalyst of Type IA, IB and IC

| | | | | | Conversion & Recovery | | | | | | | |
|---|---|---|---|---|---|---|---|---|---|---|---|---|
| | | | | Final | | | Carbon/ | | Percentage Recovery | | | |
| | | Qty | Start Temp. | Temp. | Oil | Gas | Residue | | Oil | Gas | Carbon/ | Water |
| Catalyst | Feed Material | Kgs | Deg C. | Deg C. | Kgs | Kgs | Kgs | Water | % | % | Residue % | % |
| IA | Black PP | 23.40 | 27 | 400 | 14.15 | 4.65 | 4.6 | 0 | 60.47% | 19.87% | 19.66% | 0.00% |
| IA | Black PP | 4.60 | 23 | 450 | 2.7 | 0.45 | 1.45 | 0 | 58.70% | 9.78% | 31.52% | 0.00% |
| IA | Black PP | 20.00 | 30 | 400 | 8.55 | 5.55 | 5.9 | 0 | 42.75% | 27.75% | 29.50% | 0.00% |
| IA | Enviropeel Polymer | 2.00 | 24 | 450 | 1.5 | 0.25 | 0.25 | 0 | 75.00% | 12.50% | 12.50% | 0.00% |
| IA | Enviropeel Polymer | 41.80 | 32 | 400 | 28.2 | 6.6 | 7 | 0 | 67.46% | 15.79% | 16.75% | 0.00% |
| IA | Enviropeel Polymer | 4.10 | 25 | 450 | 2.65 | 1.1 | 0.35 | 0 | 64.63% | 26.83% | 8.54% | 0.00% |
| IA | e-waste Plastic | 10.00 | 28 | 400 | 1.75 | 0.25 | 8 | 0 | 17.50% | 2.50% | 80.00% | 0.00% |
| IA | e-waste Plastic | 2.00 | 23 | 450 | 1.15 | 0.35 | 0.5 | 0 | 57.50% | 17.50% | 25.00% | 0.00% |
| IA | e-waste Plastic | 1.85 | 18 | 450 | 0.85 | 0.15 | 0.8 | 0.05 | 45.95% | 8.11% | 43.24% | 2.70% |
| IA | e-waste Plastic | 20.00 | 28 | 400 | 10.75 | 0.85 | 8.4 | 0 | 53.75% | 4.25% | 42.00% | 0.00% |
| IA | e-waste Plastic | 2.00 | 22 | 450 | 1.3 | 0.2 | 0.5 | 0 | 65.00% | 10.00% | 25.00% | 0.00% |
| IA | Laminated Plastic | 2.00 | 27 | 450 | 1.1 | 0.40 | 0.5 | 0 | 55.00% | 20.00% | 25.00% | 0.00% |
| IA | Mixed Plastic | 18.75 | 27 | 400 | 0.6 | 7.75 | 10.4 | 0 | 3.20% | 41.33% | 55.47% | 0.00% |
| IA | Mixed Plastic | 26.00 | 25 | 400 | 5.04 | 0.66 | 20.3 | 0 | 19.38% | 2.54% | 78.08% | 0.00% |
| IA | Mixed Plastic | 20.00 | 34 | 392 | 11.6 | 3.1 | 5.3 | 0 | 58.00% | 15.50% | 26.50% | 0.00% |
| IA | Mixed Plastic | 0.60 | 22 | 450 | 0.1 | 0.2 | 0.3 | 0 | 16.67% | 33.33% | 50.00% | 0.00% |
| IA | Mixed Plastic | 27.50 | 28 | 400 | 15.725 | 4.175 | 7.6 | 0 | 57.18% | 15.18% | 27.64% | 0.00% |
| IA | Mixed PP Plastic | 2.00 | 23 | 450 | 1.55 | 0.15 | 0.3 | 0 | 77.50% | 7.50% | 15.00% | 0.00% |
| IA | Paper Backed Plastic | 26.00 | 29 | 400 | 14 | 7.15 | 4.85 | 0 | 53.85% | 27.50% | 18.65% | 0.00% |
| IA | Paper Backed Plastic | 44.50 | 31 | 400 | 26.68 | 2.27 | 15.55 | 0 | 59.96% | 5.10% | 34.94% | 0.00% |
| IA | Paper Backed Plastic | 20.90 | 29 | 400 | 11.63 | 0.27 | 9 | 0 | 55.65% | 1.29% | 43.06% | 0.00% |
| IA | Paper Backed Plastic | 15.15 | 26 | 400 | 1.34 | 1.81 | 12 | 0 | 8.84% | 11.95% | 79.21% | 0.00% |
| IA | Paper Backed Plastic | 6.25 | 22 | 400 | 0 | 1.9 | 4.35 | 0 | 0.00% | 30.40% | 69.60% | 0.00% |
| IA | Paper Backed Plastic | 20.00 | 30 | 400 | 9.2 | 3 | 7.8 | 0 | 46.00% | 15.00% | 39.00% | 0.00% |
| IA | Paper Backed Plastic | 20.00 | 43 | 400 | 8.16 | 0.99 | 10.85 | 0 | 40.80% | 4.95% | 54.25% | 0.00% |
| IA | Paper Backed Plastic | 30.00 | 36 | 400 | 2.4 | 10.55 | 17.05 | 0 | 8.00% | 35.17% | 56.83% | 0.00% |
| IA | Plastic (Black PP) | 3.70 | 31 | 455 | 2.9 | 0.5 | 0.3 | 0 | 78% | 14% | 8% | 0% |
| IA | Plastic laminated Al. | 10.00 | 35 | 345 | 0.56 | 1.30 | 6.65 | 0 | 5.60% | 13.00% | 66.50% | 0.00% |
| | (1.49 kg-14.9%) | | | | | | | | | | | |
| IA | Plastic PP | 21.70 | 27 | 400 | 9.95 | 1.25 | 10.5 | 0 | 45.85% | 5.76% | 48.39% | 0.00% |
| IA | Polymer Waste | 2.00 | 21 | 450 | 1 | 0.25 | 0.75 | | 50.00% | 12.50% | 37.50% | 0.00% |
| IB | Black PP | 2.00 | 22 | 450 | 1.3 | 0.5 | 0.2 | 0 | 65.00% | 25.00% | 10.00% | 0.00% |
| IB | Black PP | 3.70 | 31 | 450 | 2.9 | 0.5 | 0.3 | 0 | 78.38% | 13.51% | 8.11% | 0.00% |
| IB | e-waste Plastic | 1.00 | 22 | 450 | 0.45 | 0.25 | 0.3 | 0 | 45.00% | 25.00% | 30.00% | 0.00% |
| IB | e-waste Plastic | 2.00 | 24 | 450 | 1.3 | 0.25 | 0.45 | 0 | 65.00% | 12.50% | 22.50% | 0.00% |
| IB | e-waste Plastic | 2.00 | 23 | 450 | 1.263 | 0.337 | 0.4 | 0 | 63.15% | 16.85% | 20.00% | 0.00% |
| IB | Mixed Plastic | 2.00 | 36 | 450 | 1.15 | 0.35 | 0.5 | 0 | 57.50% | 17.50% | 25.00% | 0.00% |
| IB | Mixed Plastic | 2.00 | 30 | 450 | 1.25 | 0.2 | 0.55 | 0 | 62.50% | 10.00% | 27.50% | 0.00% |
| IB | Mixed Plastic | 2.00 | 29 | 450 | 1.25 | 0.2 | 0.55 | 0 | 62.50% | 10.00% | 27.50% | 0.00% |
| IB | Mixed Plastic | 2.00 | 27 | 450 | 1.225 | 0.375 | 0.4 | 0 | 61% | 19% | 20% | 0% |
| IB | Mixed Plastic | 2.00 | 24 | 450 | 0.575 | 1.025 | 0.4 | 0 | 28.75% | 51.25% | 20.00% | 0.00% |
| IB | Mixed Plastic | 2.00 | 36 | 450 | 0.925 | 0.575 | 0.5 | 0 | 46.25% | 28.75% | 25.00% | 0.00% |
| IB | Mixed Plastic | 27.50 | 28 | 400 | 15.725 | 4.375 | 7.4 | 0 | 57.18% | 15.91% | 26.91% | 0.00% |
| IB | Paper Backed Plastic | 1.00 | 23 | 445 | 0.6 | 0.1 | 0.3 | 0 | 60.00% | 10.00% | 30.00% | 0.00% |
| IB | PE + PP Mix Plastci | 2.00 | 26 | 450 | 0.9 | 0.4 | 0.7 | 0 | 45.00% | 20.00% | 35.00% | 0.00% |
| IB | Plastic + Wood Chips | 2.35 | 31 | 450 | 1.29 | 0.355 | 0.705 | 0 | 55% | 15% | 30% | 0% |
| IB | Plastic from e-waste | 2.00 | 23 | 450 | 1.263 | 0.337 | 0.4 | 0 | 63% | 17% | 20% | 0% |
| IB | Polythene Carry bags | 2.30 | 29 | 450 | 1.25 | 0.35 | 0.7 | 0 | 54.35% | 15.22% | 30.43% | 0.00% |
| IB | Polythene Carry bags | 2.00 | 29 | 450 | 0.95 | 0.35 | 0.7 | 0 | 47.50% | 17.50% | 35.00% | 0.00% |
| IB | Polythene Carry bags | 2.00 | 22 | 444 | 1 | 0.3 | 0.7 | 0 | 50.00% | 15.00% | 35.00% | 0.00% |
| IB | Waste plastic bottles | 10.00 | 25 | 450 | 2.15 | 1.65 | 6.2 | 0 | 21.50% | 16.50% | 62.00% | 0.00% |
| IC | Mix shreddered plastic | 2 | 30 | 450 | 1.4 | 0.44 | 0.16 | 0 | 70.00% | 22.00% | 8.00% | 0.00% |
| IC | 3-7 mixed plastics | 8.5 | 30 | 450 | 4.2 | 0.9 | 3.4 | 0 | 49.41% | 10.59% | 40.00% | 0.00% |
| IC | CD's | 2.1 | 30 | 450 | 1.05 | 0.35 | 0.7 | 0 | 50.00% | 16.67% | 33.33% | 0.00% |
| IC | Electronica Plastics | 2 | 30 | 450 | 1.04 | 0.39 | 0.57 | 0 | 52.00% | 19.50% | 28.50% | 0.00% |
| IC | Electronica Plastics | 2 | 30 | 450 | 1.3 | 0.05 | 0.65 | 0 | 65.00% | 2.50% | 32.50% | 0.00% |
| IC | Electronica Plastics | 2 | 30 | 450 | 0.8 | 0.39 | 0.81 | 0 | 40.00% | 19.50% | 40.50% | 0.00% |
| IC | Films AND Plastics | 1.5 | 30 | 450 | 0.64 | 0.86 | 0 | 0 | 42.67% | 57.33% | 0.00% | 0.00% |
| IC | Fluffmaterial | 2 | 30 | 450 | 0.36 | 0.08 | 1.56 | 0 | 18.00% | 4.00% | 78.00% | 0.00% |
| IC | Folie + granulaat | 2 | 30 | 450 | 0.4 | 1.343 | 0.257 | 0 | 20.00% | 67.15% | 12.85% | 0.00% |
| IC | Folie + granulaat | 2 | 30 | 450 | 0.1 | 1.704 | 0.196 | 0 | 5.00% | 85.20% | 9.80% | 0.00% |
| IC | Folie + granulaat | 2 | 30 | 450 | 0.4 | 1.343 | 0.257 | 0 | 20.00% | 67.15% | 12.85% | 0.00% |
| IC | Gamesa car plastics | 3 | 30 | 450 | 0.96 | 0.884 | 1.156 | 0 | 32.00% | 29.47% | 38.53% | 0.00% |
| IC | Gamesa car plastics | 3 | 30 | 450 | 0.96 | 0.884 | 1.156 | 0 | 32.00% | 29.47% | 38.53% | 0.00% |
| IC | Guddi | 2.7 | 30 | 450 | 1.2 | 0.42 | 1.08 | 0 | 44.44% | 15.56% | 40.00% | 0.00% |
| IC | H M local | 4.46 | 30 | 450 | 1.6 | 1.92 | 0.94 | 0 | 35.87% | 43.05% | 21.08% | 0.00% |
| IC | HDPE | 9 | 30 | 450 | 7.1 | 0.55 | 1.35 | 0 | 78.89% | 6.11% | 15.00% | 0.00% |
| IC | HDPP-A | 1.6 | 30 | 450 | 0.76 | 0.55 | 0.29 | 0 | 47.50% | 34.38% | 18.13% | 0.00% |
| IC | HDPP-A | 1.6 | 30 | 450 | 0.48 | 0.8 | 0.32 | 0 | 30.00% | 50.00% | 20.00% | 0.00% |
| IC | Kali vapsi | 2.08 | 30 | 450 | 1.1 | 0.4 | 0.58 | 0 | 52.88% | 19.23% | 27.88% | 0.00% |
| IC | L D Gulla | 5 | 30 | 450 | 1.52 | 1.28 | 2.2 | 0 | 30.40% | 25.60% | 44.00% | 0.00% |
| IC | Ldpe film | 6 | 30 | 450 | 3.7 | 1.4 | 0.9 | 0 | 61.67% | 23.33% | 15.00% | 0.00% |
| IC | LDPE Mix | 1.6 | 30 | 450 | 1 | 0.21 | 0.39 | 0 | 62.50% | 13.13% | 24.38% | 0.00% |
| IC | mix plastic | 2.2 | 30 | 450 | 1.02 | 0.666 | 0.514 | 0 | 46.36% | 30.27% | 23.36% | 0.00% |
| IC | Mix Plastics | 2 | 30 | 450 | 0.64 | 0.12 | 1.24 | 0 | 32.00% | 6.00% | 62.00% | 0.00% |
| IC | Mix Shreddered Plastic | 3 | 30 | 450 | 2.32 | 0.46 | 0.22 | 0 | 77.33% | 15.33% | 7.33% | 0.00% |
| IC | Mix shreddered Plastic | 2 | 30 | 450 | 1.77 | 0.23 | 0 | 0 | 88.50% | 11.50% | 0.00% | 0.00% |
| IC | Mix shreddered Plastic + | 2 | 30 | 450 | 1.6 | 0.25 | 0.15 | 0 | 80.00% | 12.50% | 7.50% | 0.00% |
| | 1bt pet | | | | | | | | | | | |
| IC | Mix shreddered plastic + | 2 | 30 | 450 | 1.3 | 0.46 | 0.24 | 0 | 65.00% | 23.00% | 12.00% | 0.00% |
| | packadge plastic | | | | | | | | | | | |
| IC | Mix shredds | 3.26 | 30 | 450 | 1.04 | 1.06 | 1.16 | 0 | 31.90% | 32.52% | 35.58% | 0.00% |
| IC | Mix van schoon pp en PE | 1.6 | 30 | 450 | 1.421 | 0.079 | 0.1 | 0 | 88.81% | 4.94% | 6.25% | 0.00% |
| | E1 10121 | | | | | | | | | | | |
| IC | Mix van schoon pp en PE | 1.6 | 30 | 450 | 1.4 | 0.09 | 0.11 | 0 | 87.50% | 5.63% | 6.88% | 0.00% |
| | E1 10121 | | | | | | | | | | | |
| IC | Mixed plastics and bottles | 2 | 30 | 450 | 0.32 | 1.38 | 0.3 | 0 | 16.00% | 69.00% | 15.00% | 0.00% |
| IC | Mixed plastics and Films | 2 | 30 | 450 | 1.44 | 0.36 | 0.2 | 0 | 72.00% | 18.00% | 10.00% | 0.00% |
| IC | Mixed plastics with a lot | 2 | 30 | 450 | 0.52 | 1.13 | 0.35 | 0 | 26.00% | 56.50% | 17.50% | 0.00% |
| | of PET | | | | | | | | | | | |
| IC | Nylon 6 | 5 | 30 | 450 | 0.975 | 2.025 | 2 | 0 | 19.50% | 40.50% | 40.00% | 0.00% |
| IC | P.P. Gulla with Calcium | 4.48 | 30 | 450 | 0.8 | 1.68 | 2 | 0 | 17.86% | 37.50% | 44.64% | 0.00% |
| IC | PE-Blau | 0.7 | 30 | 450 | 0.56 | 0.04 | 0.1 | 0 | 80.00% | 5.71% | 14.29% | 0.00% |
| IC | PET | 2 | 30 | 450 | 0.08 | 1.32 | 0.6 | 0 | 4.00% | 66.00% | 30.00% | 0.00% |
| IC | Plastic | 1.6 | 30 | 450 | 1.28 | 0.22 | 0.1 | 0 | 80.00% | 13.75% | 6.25% | 0.00% |
| IC | Plastic | 1.6 | 30 | 450 | 1.4 | 0.09 | 0.11 | 0 | 87.50% | 5.63% | 6.88% | 0.00% |
| IC | Plastic | 1.6 | 30 | 450 | 1 | 0.21 | 0.39 | 0 | 62.50% | 13.13% | 24.38% | 0.00% |
| IC | Plastic | 1.6 | 30 | 450 | 0.48 | 0.8 | 0.32 | 0 | 30.00% | 50.00% | 20.00% | 0.00% |
| IC | Plastic | 1.6 | 30 | 450 | 0.76 | 0.55 | 0.29 | 0 | 47.50% | 34.38% | 18.13% | 0.00% |
| IC | Plastic | 2.125 | 30 | 450 | 1.625 | 0.5 | 0 | 0 | 76.47% | 23.53% | 0.00% | 0.00% |
| IC | Plastic | 3 | 30 | 450 | 1.614 | 0.918 | 0.468 | 0 | 53.80% | 30.60% | 15.60% | 0.00% |
| IC | Plastic | 1.8 | 30 | 450 | 0.179 | 0.661 | 0.96 | 0 | 9.94% | 36.72% | 53.33% | 0.00% |
| IC | Plastic | 1.944 | 30 | 450 | 0.36 | 0.554 | 1.03 | 0 | 18.52% | 28.50% | 52.98% | 0.00% |
| IC | Plastic | 0.7 | 30 | 450 | 0.56 | 0.04 | 0.1 | 0 | 80.00% | 5.71% | 14.29% | 0.00% |
| IC | Plastic | 2 | 30 | 450 | 0.52 | 0.42 | 1.06 | 0 | 26.00% | 21.00% | 53.00% | 0.00% |
| IC | Plastic | 2.1 | 30 | 450 | 0.218 | 0.682 | 1.2 | 0 | 10.38% | 32.48% | 57.14% | 0.00% |
| IC | Plastic Cartridges | 2.027 | 30 | 450 | 0.323 | 0.794 | 0.91 | 0 | 15.93% | 39.17% | 44.89% | 0.00% |
| IC | PP, HDPE, PE | 2 | 30 | 450 | 1.5 | 0.5 | 0 | 0 | 75.00% | 25.00% | 0.00% | 0.00% |
| IC | PP talco, shredded light | 2 | 30 | 450 | 0.182 | 1.218 | 0.6 | 0 | 9.10% | 60.90% | 30.00% | 0.00% |
| | plastics | | | | | | | | | | | |
| IC | shredderd plastic | 2 | 30 | 450 | 1.78 | 0.08 | 0.14 | 0 | 89.00% | 4.00% | 7.00% | 0.00% |
| | gildenhaus | | | | | | | | | | | |
| IC | shreddered plastic | 2 | 30 | 450 | 1.78 | 0.22 | 0 | 0 | 89.00% | 11.00% | 0.00% | 0.00% |
| | gildenhaus | | | | | | | | | | | |
| IC | Teflon | 2.54 | 30 | 450 | 0.13 | 1.085 | 1.325 | 0 | 5.12% | 42.72% | 52.17% | 0.00% |

What is claimed is:

1. An external, fixed bed, agglomerated nano catalyst for conversion of waste material into hydrocarbon fuel fractions and carbon, said catalyst having formula I:
AₓB_{y}O_{z}.Qₙ.(OH)ₘ I
wherein, ‘A’ is a transition element selected from Ti, Mn, Cr, Fe, Ni, Nb, Mo, Zr, Hf, W, Ta, Zn, either alone or mixture thereof in metallic form or as oxide or as hydroxide; ‘B’ represents Sc, Yt, La, Ce, Nd, Pr, Th either alone or mixture thereof in metallic form or as oxide or as hydroxide; optionally along with an organic binder,
‘x’ is the number in the range of about 0-2; ‘y’ is the number in the range of about 0-2; ‘m’ is the number in the range of about 0-4; ‘n’ is the number 0 or 1;
‘z’ is the number of oxygen atoms needed to fulfill the requirements of the elements possible;
‘Q’ represents montmorillonate clay or its derivatives;
with the proviso, when ‘x’ is 0; ‘y’ is equal to 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1, optionally along with an organic binder;
with the proviso, when ‘y’ is 0; ‘x’ is equal to 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1, optionally along with an organic binder;
with the proviso, when ‘x’ and ‘y’ both are present selected from 1 or 2; ‘m’ is the number in the range 0-4; ‘z’ is the number of oxygen atoms needed to fulfill the requirements of the elements possible; ‘Q’ represents montmorillonate clay or its derivatives and ‘n’ is the number 0 or 1 along with an organic binder.

2. The external, fixed bed, agglomerated nano catalyst according to claim 1, wherein, catalyst comprises ‘A’ in metallic form or as oxide or as hydroxide in the range of 10-65% by weight; ‘B’ in metallic form or as oxide or as hydroxide in the range of 5-25% by weight; ‘Q’ in the range of 30-90% by weight and optionally the organic binder in the range of 5-12% by weight either alone or in combination thereof.

3. The external, fixed bed, agglomerated nano catalyst according to claim 1, wherein organic binder selected from Titanium Tetraflouride, ethylene glycol, ethylene glycol monomethylether (EGME), methyl cellulose, tetrafloroethylyne, poly(diallyl-dimethylammonium, L-lysine, L-proline, Phenolics, Ethenol homoPolymers.

4. The external, fixed bed, agglomerated nano catalyst according to claim 1, wherein the catalyst is selected from the group consisting of;
a. Catalyst type IA comprising 30% by weight of element ‘A’ as hydroxide, 10% by weight organic binder and 60% by weight of element ‘A’ as oxide,
b. Catalyst type IB comprising 12% by weight of element ‘B’ in metallic form and 88% by weight montmorillonate clay or its derivatives,
c. Catalyst type IC comprising 6% by weight element ‘B’ in metallic form, 44% by weight montmorillonate clay or its derivatives (Q), 30% by weight element ‘A’ as oxide, 15% by weight element ‘A’ as hydroxide and 5% by weight binder.

5. The external, fixed bed, agglomerated nano catalyst according to claim 4, wherein catalyst type IA comprises 30% by weight of titanium hydroxide, 10% by weight ethenol homopolymer and 60% by weight of titanium oxide.

6. The external, fixed bed, agglomerated nano catalyst according to claim 4, wherein catalyst type IB comprises 12% by weight of Lanthanum and 88% by weight montmorillonate clay or its derivatives.

7. The external, fixed bed, agglomerated nano catalyst according to claim 4, wherein catalyst type IC comprises 6% by weight of lanthanum, 44% by weight montmorillonate clay or its derivatives, 30% by weight titanium oxide, 15% by weight element titanium hydroxide and 5% by weight of ethenol homopolymer.

8. The external, fixed bed, agglomerated nano catalyst according to claim 1, wherein the particle size of the elements in said catalyst is in the range of 20-100 nm, which is agglomerated to obtain granules of particle size in the range of 100-500 microns.

9. The external, fixed bed, agglomerated nano catalyst according to claim 1, wherein said catalyst is a pyro-catalyst at a temperature in the range of 10-80° C. and can withstand temperature upto 500° C.

10. The external, fixed bed, agglomerated nano catalyst according to claim 1, wherein catalyst is in a different phase from the waste material.

11. The external, fixed bed, agglomerated nano catalyst according to claim 1, wherein the nanocatalyst has a surface area in the range of 35-250 mt²/gm.

12. The external, fixed bed, agglomerated nano catalyst according to claim 1, wherein the nanocatalyst has a thickness in the range of 1 cm to 100 cms and beyond.

13. The external, fixed bed, agglomerated nano catalyst catalyst according to claim 1, wherein the hydrocarbon product composition varies with the thickness of the catalyst bed.

14. A process for the preparation of the external, fixed bed, agglomerated nano catalyst according to claim 1, comprising;
a. Subjecting the nanoparticles of particles of the elements either in metallic or oxide or hydroxide form either alone or combination thereof to cryogenic grinding at a temperature in the range of −40° C. to −50° C. followed by sieving and segregating to obtain nano particles of the size in the range of 20-100 nm;
b. Recycling the nanoparticles of particle size less than 20 nm and greater than 100 nm obtained after segregation to grinding of step (a);
c. adding a binder or montmorillonite clay to step (a) and blending to form a slurry;
d. spraying the slurry into a fine spray through nozzle onto the belt, drying, sieving, segregating to obtain desired agglomerated nano catalyst with the particle size in the range of 100-500 microns; and
e. recycling the particles of particle size less than 100 microns and greater than 500 microns obtained in step (d) to step (c).

15. The process according to claim 14, further comprising adding an element selected from the lanthanide or actinide series or a transition metal to the weighed nanoparticles with particle size in the range of 20-100 nm of step a.,
followed by addition of water, montmorillonite clay or its derivatives, optionally a binder to obtain agglomerated nano catalysts.

16. The process for the preparation of agglomerated nano catalyst according to claim 14, wherein the binder is selected from the group consisting of Titanium Tetraflouride, ethylene glycol, ethylene glycol monomethylether (EGME), methyl cellulose, tetrafloroethylyne, poly(diallyl-dimethylammonium, L-lysine, L-proline, Phenolics, Ethenol homoPolymers.

17. The process for the preparation of the external, fixed bed, agglomerated nano catalyst type IA according to claim 5, comprising;
a. subjecting nanoparticles of 30% by weight of titanium hydroxide, 60% by weight of titanium oxide to cryogenic grinding followed by sieving and segregating to obtain nano particles of the size in the range of 20-100 nm;
b. recycling the nanoparticles of particle size less than 20 nm and greater than 100 nm obtained after segregation to grinding of step (a);
c. adding 10% by weight of binder to step (a) and blending to form a slurry;
d. spraying the slurry into a fine spray through nozzle onto the belt, drying, sieving, segregating to obtain desired agglomerated nano catalyst type IA with the particle size in the range of 100-500 microns; and
e. recycling the particles of particle size less than 100 microns and greater than 500 microns obtained in step (d) to step (c).

18. The process for the preparation of the external, fixed bed, agglomerated nano catalyst type IB according to claim 6, comprising;
a. subjecting the nanoparticles of particles of 12% by weight of lanthanum to cryogenic grinding followed by sieving and segregating to obtain nano particles of the size in the range of 20-100 nm;
b. recycling the nanoparticles of particle size less than 20 nm and greater than 100 nm obtained after segregation to grinding of step a;
c. adding 88% by weight of montmorillonite clay to step (a) and blending to form a slurry;
d. spraying the slurry into a fine spray through nozzle onto the belt, drying, sieving, segregating to obtain desired agglomerated nano catalyst type IB with the particle size in the range of 100-500 microns; and
e. recycling the particles of particle size less than 100 microns and greater than 500 microns obtained in step (d) to step (c).

19. The process according to claim 14 for the preparation of agglomerated nano catalyst type IC, said process comprising;
a. adding elements selected from lanthanide or actinide series to the weighed nanoparticles of oxides and hydroxides of transition metal with particle size in the range of 20-100 nm followed by addition of water, montmorillointe clay or its derivatives, optionally a binder and blending to form a slurry;
b. spraying the slurry into a fine spray through nozzle onto the belt, drying, sieving, segregating to obtain desired agglomerated nano catalyst with the particle size in the range of 100-500 microns; and
c. recycling the particles of particle size less than 100 microns and greater than 500 microns obtained in step (b) to step (a).

20. The external, fixed bed, agglomerated nano catalyst according to claim 1, wherein the fixed bed catalyst is single or multilayered.

21. The external, fixed bed, agglomerated nano catalyst according to claim 1, wherein said catalyst can bring about vapor phase decomposition of waste materials selected from the group consisting of biomass, plastic wastes, rubber wastes, municipal solid sewage waste, electronic waste, petroleum wastes, edible and non-edible oil cakes, edible and non-edible oil seeds, animal wastes, vegetable fats, animal fats, and combinations thereof, into usable combustible hydrocarbon fuel and solid carbon.

22. A method to convert homogenous and heterogeneous waste materials into hydrocarbon fuel fractions and carbon, said method comprising vapor phase decomposition of homogenous and/or heterogeneous waste material into hydrocarbon fuel and carbon using the external, fixed bed, agglomerated nano catalyst of claim 1.
